(19) United States
(12) Patent Application Publication
(10) Pub. No.: US 2025/0282550 A1
(43) Pub. Date: Sep. 11, 2025

(54) AUTONOMOUS AUGMENTATION TO A PICK-PUT FULFILLMENT SYSTEM

(71) Applicant: FastFetch Corporation, Pendleton, SC (US)

(72) Inventor: John C. Peck, Seneca, SC (US)

(73) Assignee: FasFetch Corporation, Pendleton, SC (US)

(21) Appl. No.: 18/599,735

(22) Filed: Mar. 8, 2024

(51) Int. Cl. B65G 1/137

(52) U.S. Cl. CPC B65G 1/1373

(57) ABSTRACT

This system can include a pick-put controller in communications with an AMR and using close proximity communications to eliminate the need for facility wide real time transmissions with a central server and facilitate the picking and putting process in facilities that cannot or do not have longer range wireless communications. The pick-put controller can communicate with a bay controller only with close proximity communications. The pick-put controller can transmit instructions to the bay controller which can actuate one or more light indicators. The pick-put controller can direct the AMR to a desired location. The pick-put controller can send instructions to one or more AMR light assemblies. The pick-put controller can record picking and putting events in a storage system which can include a storage database. The AMR can be instructed to travel to a packaging area and upon removal of items picked, return for more order fulfilment.

### BACKGROUND OF THE SYSTEM

### 1) Field of the System

This system is directed to a pick-put system utilizing autonomous mobile robots (AMRs) and a remote, localized and disparate computer system to augment the tasks of a pick-put worker wherein the AMR and computer system can be operatively associated so as to be used asynchronously and locally to provide a pick-put system in multiple environments.

### 2) Description of the Related Art

E-commerce and online sales have enjoyed an explosive growth that has been reported to be three times the rate of total retail sales according to a report issued by Tompkins Supply Chain Consortium. This trend, however, is also increasing the pressure on retailers and vendors in the areas of order fulfillment, returns processing and meeting the quick turnaround time expected by consumers. In order to meet these order fulfillment demands, attempts to improve the order fulfillment efficiencies have been presented such as shown in United States Patent Application Publication 2014/0350717. There have also been attempts to automate the order fulfillment process such as shown in U.S. Pat. No. 9,919,872. These attempts include an order fulfillment system and method of fulfilling orders, each with at least one article, includes at least one mobile robotic unit that is capable of autonomous movement in an order fulfillment facility such as in U.S. Pat. No. 11,602,857 and United States Patent Publication 2023/0219237.

However, these attempts fail to provide a solution that is acceptable in all environments since they rely upon real time communications with a central server and to constantly receive data from the central server for operations. For example, U.S. Pat. No. 7,591,630 discloses the need for a master computer in communication with vehicle where the vehicle includes an electronics module containing an embedded control computer wherein the embedded computer communicates with a system master computer. Therefore, communication between the vehicle and the master computer is required.

When in certain environments, such as the warehouse environment, this requires that there be a wireless network sufficient to reach the operational area of the AMR, which generally means the entire floor space of the location needs to have communications between the AMR and the master computer. Some attempts to provide this wireless network connection include adding access points that amplify or repeat wireless communications. Access points create many issues that can result from having an unnecessary abundance of access points to not having enough. The interference between access points can cause reduced performance, low or lost data transmission, lack of connectivity, unnecessary reconnections which frustrates the purpose of the pick-put systems. Too few access points cause devices to not transition properly from one access point to another which can result in a temporary failure of the system, errors in order fulfilment and loss of data. Too few access points result in devices dropping the connection resulting in delays, even when the device can successfully refresh the connection after moving to another location.

Another common problem with wireless networks in locations is the actual material that is stored in the facility. The stored material may block transmission and consequently impact the network performance due to material density, make up, composition, storage height, distance to the ceiling, distance to bays, space between bays, and the like. For example, facilities that store liquid can interfere with wireless communications since such signals do not transmit through liquid media very well. Because access points can be installed in the ceiling or rafters of a facility, the construction material of the ceiling can also impact performance. For example, a metal warehouse can severely impact communications performance. Further, this is not static. When the inventory of the warehouse changes, the performance of the wireless network can change making it impractical to reorganize access points with each change in inventory.

Systems that rely upon a wireless network for communications with a central service have substantial challenges. For example, U.S. Pat. No. 10,071,856 discloses that sensors positioned on a robotic device or within the warehouse environment may transmit data to a computing system (e.g., a warehouse management system), which may then generate a route, path, or other navigation instructions for a robotic device. This system fails when the computing system (e.g., a warehouse management system or master computer) fails, communications or power to the computing system is lost or other disruption in the communications from the AMR to the master computer. It would be advantageous for a pick-put system to be functional even when communications or power to a controlling or master computer system is lost. It would be advantageous if the pick-put system included containers, such as mobile units, that can operate independently, asynchronously, and autonomously.

Further, while technology has advanced beyond exclusively manual systems of pick-put operations, they are more prone to supply chain disruptions including those that are not readily predictable. For example, the pandemic beginning in the year 2020 created manufacturing and supply chain disruptions for many reasons including the need for flexible work hours, social distancing, required use of protective clothing and equipment, masks, non-sharing of work tools and equipment, during and between shift cleanings and other changes to normal operations, which largely reduced productivity rates and corresponding production levels. It would be advantageous to have a pick-put system that was designed to allow efficient picking and putting of items while minimizing contact, following governmental agency protocols and improved efficiencies to meet increased demand.

In general terms, filling orders from stored inventories can include at least three steps: locating the precise item in the storage facility, retrieving (or picking) the desired quantity of that item, and storing (or putting) the retrieved items into designated containers or receptacles. Examples of such systems and technology applications to order fulfillment can be found in U.S. Pat. Nos. 6,775,588, 8,019,463, 10,672,094, and 10,961,053 and United States Applications 2021/0276804 and 2021/0163225 all incorporated by reference.

These basic steps may apply to a variety of situations in which items must be identified, selected, and distributed or placed in a second location. Frequently this process is generally described in terms of order fulfillment in a warehouse or distribution center. Storage in a facility may be viewed as a nested or hierarchical arrangement with zones containing aisles with bays (e.g., shelving units) arranged along the aisles, shelves or storage containers located in or on a bay, and locations containing items positioned in or on a shelf. Thus, the location of a specific item, wherein the item can be associated with an item identifier such as one commonly referred to as a Stock Keeping Unit (SKU), could be an “address” in the storage facility comprising the zone, the aisle in that zone, the bay along that aisle, a shelf in that bay, and a position on the shelf. It is also possible to have a location indicator or code where the location indicator can be associated with the zone, aisle, bay, shelf, and position. So long as a protocol exists to associate one item identifier with each unique combination of zone, aisle, bay, shelf and position, identification of a particular item is unnecessary for picking, since the unique combination, sometime called the location code of the item, in a facility is sufficient.

In an exclusively manual system, an employee receives an order for a specific item or group of items. Either by memory, which is subject to error, or by reference to a facility map or plan, the employee must identify the location of the item using the location code, go to that location, pick the required quantity of that item for the order, and place the item in an appropriate receptacle. This process is repeated until a given order is filled, at which time the employee will return to a designated point for subsequent processing such as labeling, packing or shipping of the items in the order. Multiple opportunities for errors exist, from misreading the storage facility location code label, to selecting from an incorrect but adjacent shelf or other storage receptacle, to picking the wrong quantity of the correct item, or to putting the correct items in an incorrect receptacle for subsequent packing or shipping. In addition, many separate orders may require the same item, but in an exclusively manual system single order picking can be employed so that significant inefficiencies result with repeated trips to pick each order separately. Multiple order (batch) order picking, in which many orders are picked with a single trip through the facility, is rarely used with manual systems.

U.S. Pat. Nos. 5,505,473 and 5,877,962 describe and claim respectively a computer-based system to facilitate proper placement of articles picked by an attendant from inventory storage shelves and deposited in delivery containers mounted on a cart and a method for the practical utilization of the system. In addition, the system and related methods include an optional beacon light system to indicate the location of inventory items to be picked or retrieved. These references depend on a single intelligent element or computer that must maintain constant two-way radio communication between a receiver/central control unit mounted on a cart and between the optional beacon system located on storage shelves. A scanner mounted on the cart is used to read codes on either the location or item to be picked to validate the designated pick. A drawback of this invention is that a cart attendant must visually find the item location in the vicinity of the beacon and scan a barcode on either the product or location containing a product as a means of confirming the correct item is being picked. After scanning a correct barcode, lights on the cart locations are illuminated designating where the picked items should be placed.

In some systems, the worker can be directed by a light system such as shown in United States Patent Application Publication 2017/0015502 and 2018/0286002 and U.S. Pat. Nos. 6,775,588 and 8,019,463.

U.S. Pat. No. 6,775,588 shows one system using a unique distributed intelligence, wireless, light-directed pick-put system having a bi-directional, dual transmitter/receiver element in wired communication with a portable computer and in wired or wireless communication with put- and pick-controller units in which the portable computer translates order location data into light addresses that are communicated by wireless means to a pick-controller unit positioned on a storage bay and in electrical communication with a plurality of light assemblies, which can include intelligent light assemblies, each of which can include a numeric or alphanumeric display and computer readable instructions that determine its operational behavior. Each intelligent light assembly is positioned at a unique location such that in response to the communicated, translated, order location data, a specific intelligent light assembly is activated, illuminating a character display, and thereby indicating the location and quantity of the item identifier to be retrieved from that location. Further, the portable computer, the bi-directional, dual transmitter/receiver element, and put-controller unit are positioned on a mobile element that has a plurality of receptacles positioned on it, each receptacle having a unique, intelligent light assembly positioned near it and wired to the put-controller unit such that in response to translated location data communicated from the portable computer through the bi-directional, dual transmitter/receiver element and then through the put-controller unit, a character display is activated indicating the quantities of any retrieved item identifier to be put into each of one or more indicated receptacles. Each intelligent light assembly includes a momentary contact switch which provides the means by which the attendant indicates that the designated pick or put has been completed.

Another concern that is not directly related to supply disruptions but is occurring contemporaneously with disruptions, is the increased need for information technology security. U.S. Pat. No. 9,734,169 illustrates this issue and states that policies which dictate how the information files are handled in light of legal, security and compliance risk factors are important. Further, this reference states that most commentators believed that a breach of confidentiality and misuse of data was a result of an outsider “hacker” getting access to enterprise information by penetrating a firewall or other security system. While this patent states that it attempts to provide tools for securing secret or security sensitive sec-con data in the enterprise computer system, it does not disclose how data exposure can be minimized to increase security concerns.

Another disadvantage with the AMR in the pick-put industry is with interoperability. Current solutions do not provide for the ability of multiple robot systems to operate in a single location as each has its own methods of self-localization, integration with warehouse management system, speeds, communications with central servers and the ability to handle the changing floorplan of a storage facility. It would be advantageous to have a system that allowed for multiple robotic systems from multiple vendors to operate together in a facility. It would also be advantageous for the system to allow for self-location and location identification regardless of the floorplan modifications to it. Multiple AMR systems require multiple master computer systems, each managing its own vehicles.

It would be advantageous to have a system that allows for the pick-put process to occur without a mandatory requirement for AMRs or containers to be in continuous communications with a centralized system such as a central server.

It would also be advantageous to have a system that uses data transfer which is less susceptible to unauthorized access, power failures and other information technology interruptions.

It would also be advantageous to have a system that allows for multiple systems to operate cohesively in a facility without duplications such as without multiple master computer systems.

### BRIEF SUMMARY OF THE SYSTEM

### Brief Description of the Several Views of the Drawings

The construction designed to carry out the system will hereinafter be described, together with other features thereof. The system will be more readily understood from a reading of the following specification and by reference to the accompanying drawings forming a part thereof, wherein an example of the system is shown and wherein:

FIG. 1A is a schematic of aspects of the system.

FIG. 1B is a schematic of aspects of the system.

FIG. 1C is a schematic of aspects of the system.

FIG. 2 is a schematic of aspects of the system.

FIG. 3 is a schematic of aspects of the system.

FIG. 4 is a top-down view of aspects of the system.

FIG. 5 is a flowchart of aspects of the system.

FIG. 6 is a schematic of aspects of the system.

FIG. 7 is a flow chart of aspects of the system.

FIG. 8 is a schematic of aspects of the system.

FIG. 9 is a schematic of aspects of the system.

### DETAILED DESCRIPTION OF THE SYSTEM

With reference to the drawings, the system will now be described in more detail. An autonomous mobile robot (AMR) is a type of robot that can understand and move through its environment without human control. In some embodiments, the AMR can use sensors, artificial intelligence, machine learning, and computer readable instructions to compute a travel path that is used to interpret and navigate through its environment, The AMR can be untethered from wired power. An AMR can include navigation techniques in its operation and software to have collision avoidance that can include the ability to slow, stop, or reroute the path around the object, if needed, and then continue with their task so that changes in the environment can be managed autonomously.

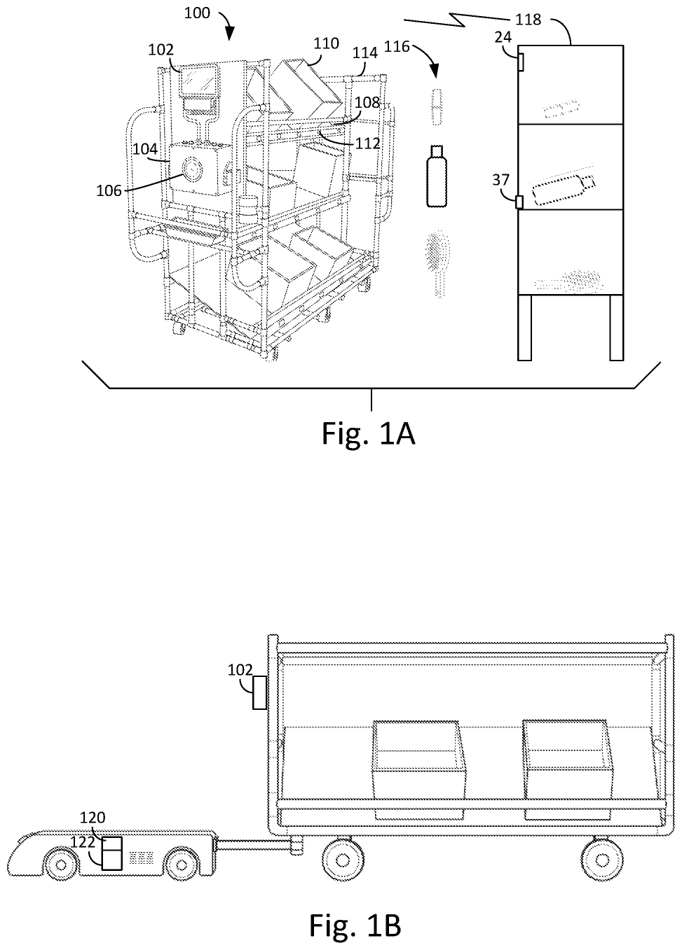

Referring FIGS. 1A through 1C, an AMR 100 can include an AMR controller, pick-put controller 102 in communication with the AMR controller, and can include a computer readable medium, power supply, one or more input connections (wired or wireless), one or more output connections (wired or wireless), a display and any combination. The pick-put controller can be a computer device that can communicate directly with a bay controller, AMR controller, cart controller and other computer systems. The AMR can support a cart or can pull a cart.

The cart controller can be hardware and software that allows the pick-put controller to communicate and provide the hardware, software, and functionality described herein. The pick-put controller should not be understood to be limited to requiring a cart controller as the pick-put controller can be the hardware and perform the processes and execute the computer readable instructions herein independently, in one embodiment.

In one embodiment, the pick-put controller 102 can be in communication with an AMR controller 120 through an interface 122 so that the protocol between the pick-put controller and the AMR controller can be varied from AMR to AMR. The pick-put controller can be connected to electronics housing 104 that can include connections, power supply (removable, rechargeable and the like), wiring, connections for input and output and other components. For example, the housing can allow a barcode scanner to be connected and send and receive information to the pick-put controller. In one embodiment, the pick-put controller can be directly connected and communicate to such components. The AMR can be attached to a cart carrying containers or can include shelving that carries containers.

A transceiver can be connected to the housing, included in the pick-put controller or any combination and can be adapted for transmitting and receiving wireless information. For example, the pick-put controller can be a mobile computer device which can include an integrated transceiver such as the 5765 RF transceiver found in one popular mobile device. The pick-put controller readable medium can store a digital representation of one or more orders. An order can represent one or items that are to be placed in a container to be shipped to a customer. The order can be transmitted to the pick-put controller through wired or wireless communications and can be stored on the pick-put controller so that no further communications with the order source, such as a facilities computer, is needed. Therefore, communication between the AMR and a master computer is not needed, which alleviates the disadvantages with current AMR technology.

The pick-put controller can include a display that can be used to display information to a user that can include a photo of the item to be picked, the location code of an item, the quantity of an item to be picked, the location where the ARM and pick-put controller has been instructed to travel, the current location of the AMR and pick-put controller, order information, and other information that can be presented to the worker. An audio assembly 106 can be in communication with the pick-put controller to provide audio information to the worker.

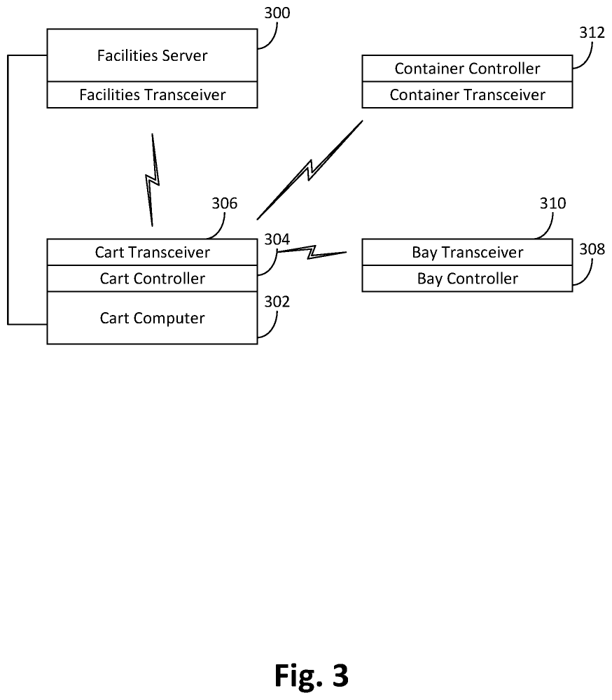

The AMR can include containers that can be held on shelves. The ARM can also be connected to one or more cart shelves 108 that can hold one or more containers 110. The pick-put controller can transmit to the AMR controller the location of the items to be picked from the facility and placed in the containers. Therefore, the AMR can autonomously travel to a pick location based upon instructions from the pick-put controller without the need to communicate with a master computer. The pick-put controller, having one or more orders, can determine the path associated with the order fulfilment and the facility and direct the AMR to travel to the appropriate locations and path. The pick-put controller can determine that it is at the correct picking location when it receives an acknowledgement from the bay controller. The bay controller and the pick-put controller can enter into a communications session when the pick-put controller and the bay controller are within a predetermined close proximity range (e.g., range 408 shown in FIG. 4). The pick-put controller can send an instruction to the AMR informing the AMR AMR to move to the location allowing for picking of items according to an order stored on the pick-put controller. Therefore, there is no need for the AMR to communicate with a master computer or to have real-time continuous communications with a central server in order to be positioned around the facility. The pick-put controller can then communicate with the bay controller to indicate which item to pick.

In one embodiment, the pick-put controller informs the AMR of the aisle where item(s) are to be picked. The AMR can proceed to and down the aisle so when the AMR is in close proximity to a require picking location, the pick-put controller can receive information from a bay controller and inform the AMR that it is so stop at that location to perform picking.

When the AMR is positioned at the pick location, the worker can pick items from storage locations in the facility and can place them in the containers.

The containers can be associated with a cart light assembly 112 so that the worker can be shown instructions concerning container 110 or the location on the AMR into which to place an item picked from the bay and where it should be placed on the container associated with the AMR (i.e., a put item). An order identifier, such as a barcode, on a container 110 can be scanned and the cart light assembly can be actuated indicating the cart position where the container should be placed. By using the cart light assembly associated with container 110 and placing it on the AMR, the pick-put controller can later actuate the cart light assembly indicating where an item that is picked should be put.

In one embodiment, the cart light assembly can actuate and display a location associated with a container to indicate to the worker the location into which the item should be placed. In one embodiment, an AMR includes a frame 114 that can be used to contain the shelves and receive container 110. In one embodiment, the AMR can pull or push the frame to the designated location. Each container can receive one or more items 116 from a bay 118. One or more bays can be positioned in a facility and the bay can include one or more shelves with one or more positions to hold items.

In one embodiment, the pick-put controller can determine that a conflicting AMR is at a location and in the picking process at the location where the pick-put controller is seeking to begin the pick put process. Therefore, the pick-put controller can instructed the AMR to travel to a second location. The AMR can be sent to an a second location and begin the pick-put process according to the set of orders on the pick-put controller. When the pick-put process is completed at the second location, the pick-put controller can attempt to return to the first location. Therefore, the pick-put controller can reorder the pick-put process for the set of orders according to bay controller occupancy with other pick-put controllers and AMR controllers.

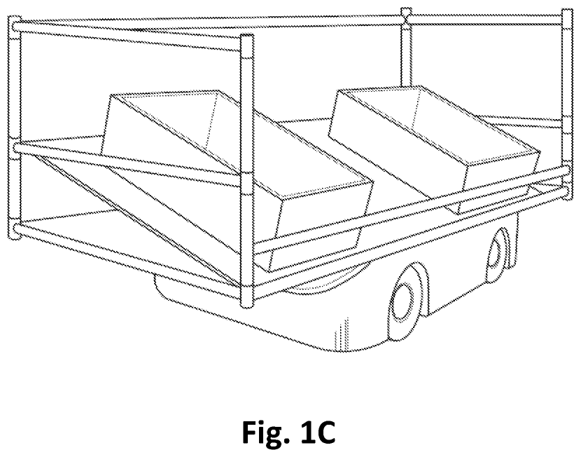

Referring to FIG. 2, a bay 200 is shown. The bay can be positioned in a facility and used to receive and store items. For example, the bay can have bins 202. The bay can have open areas 204 that can be used for storing larger items. The bay can include a bay controller 206 and can include or be in communication with a bay transceiver 208. The bay controller, in one embodiment, can be adapted to transmit a bay identifier using a bay transceiver 208. The bay identifier can be a unique identifier to distinguish the bay and its location from other bays and locations in the facility. The bay transceiver can be used for transmission of information and data to other components of the system such as the pick-put controller and AMR controller by transmitting information that can be received by the transceiver that can be included in the pick-put controller and the AMR controller. For example, the information that can be exchanged between the bay controller, the pick-put controller, the AMR controller and any combination thereof and can include information representing that a switch was actuating on the bay or a container that is associated with the AMR or cart, a component of the bay is malfunctioning, assignment or modification of the bay identifier, the quantity of an item to be picked or that has been picked or the like.

In one embodiment, the bay transceiver is a transmit only assembly and can be active or passive. For example, for a passive bay transceiver, a pick-put controller and AMR controller in a transmission range can transmit to the bay transceiver thereby powering and triggering the bay transceiver to transmit a bay identification. In an active bay transceiver, the bar transceiver can transmit the bay identification periodically, such as in the range of several times a second to every few seconds. The bay controller can include a light indicator that can be a bay light assembly 210 that can be associated with a bin or open area so that items in such a location can be associated with the bin or open area. The bay controller can be configured to actuate the bay light assembly representing the location of an item on the bay and can also indicate the quantity to be retrieved. The bay light assembly can be activated in response to receiving an item pick request transmission from the pick-put controller.

The bay can include light indicators 212 that can be a series of lights adapted to be actuated in response to information received from the pick-put controller and AMR. In one embodiment, the light indicators can be a strip of light emitting diodes (LED) that can be actuated so that a contiguous segment of the LEDs are associated with a location on the bay. The bay controller can include an LED controller or be in communication with an LED controller so that when an item is to be picked from the bay, the bay controller can actuate a segment of LEDs 214 that can designate a container or area. In this embodiment, the individual LEDs of a segment can be actuated to designate locations on the bay.

The bay transceiver can have a bay transmission range so that the information transmitted by the bay controller extends to the transmission range and no further. In one embodiment, the bay transmission range can be several feet to several hundred or even a thousand feet. The bay controller can also deactivate the bay light assembly when the pick-put controller or AMR controller indicates to the bay controller that the items in an order have been picked or that the items on the specific bay or location on the bay have been completed or cannot be completed. In some instances, the order cannot be completed due to lack of inventory or other factor, so that the order picking and putting process is completed without all items on the order having been picked and put on a cart or container associated with the AMR. In this case, the worker can indicate to the pick-put controller that the item is not available and request the bay controller to deactivate the bay light assembly or light strip. The bay light assembly and light strip can also be deactivated when the items to be picked in the order are picked and placed on a container associated with an AMR.

In one embodiment, the bay controller or bay indicator can use close proximity transmission that includes short-range, high-frequency wireless communication technology that can be bi-directional, have a transmission range that is 10 feet or less, and have a bit rate of 1.0 Kbps or higher. In one embodiment, the bit rate is in the range of 1.0 Kbps to 3.0 Kbps to reduce error transmission rates. In one embodiment, the bay controller or bay light assembly can use a narrow, low-power, non-propagating magnetic field that can be received by the pick-put controller and AMR controller.

In one embodiment, the bay transceiver includes an infrared transmitter so that the transmission range can be limited by reducing the power of the IR thereby limiting the range of the transmission. In one embodiment, a transmitter coil can be used in the pick-put controller or other assembly associated with the pick-put controller to modulate a magnetic field which is measured by a receiver coil in the bay controller or pick-put controller. The transmission range can be adjusted to 10 feet or less.

The pick-put controller can be carried on the AMR, can be removeable attached to the AMR or can be separated from the AMR and in communications with the AMR. The pick-put controller can include a set of pick-put controller readable instructions that can be adapted to direct a user, AMR, cart, and other object to a facility location according to the order. The user is visually or audibly instructed to move to the location and the AMR can be electronically instructed to move to a position corresponding to an item location on a bay within the facility. The pick-put controller can transmit information that includes a bay controller address (e.g., a bay identifier). When the pick-put controller is disposed in close proximity to the bay controller, so that the bay controller can receive information transmitted from the pick-put controller, the bay controller can transmit its bay identifier to the pick-put controller indicating that the bay controller and the pick-put controller should go into a transmission session. In the transmission session, the bay controller can inform other pick-put controllers that the bay controller is not able to process additional pick, put or other information. In the transmission session, the pick-put controller can transmit to the bay controller that item information and the bay controller can actuate the bay light assembly or bay light strip indicating the location of an item to be picked. The pick-put controller can display the quantity to be picked from the designated bay location. If the bay controller is connected to a light assembly with a numeric display, the bay controller can direct the light assembly to display the quantity of the item to be picked. The pick-put controller can actuate a cart light assembly indicating where a picked item is to be placed on the cart. Upon completion of all picked items, or if required items are not available, the transmission session can conclude.

The transceiver can have a limited transmission range so that the bay controller does not receive transmissions from the cart transceiver until the pick-put controller is within the limited transmission range. When the pick-put controller is within the limited transmission range and the transmitted message contains a different address from the address of the receiving bay controller, the receiving bay controller ignores the message. If the transmitted message contains the address of the receiving bay controller, the pick-put controller and the bay controller can engage in a handshake protocol that can begin a transmission session and can include the following: the pick-put controller transmits a poll message containing the target bay controller address, the bay controller receives the poll message with its address, the target bay controller transmits an acknowledgment message, the pick-put controller receives the acknowledgement message, the pick-put controller sends a pick item request, the bay controller receives the pick item request and actuates a bay light assembly to indicate the location and quantity of one or more items to be picked. The pick-put controller continues sending poll messages through the cart transceiver and receiving acknowledgement replies from the bay controller until the worker picks the indicated quantity of an item indicated on the bay by the bay light assembly or the bay light strip and actuates a switch, such as a proximity switch, by placing an object sufficiently close to the switch in the bay light assembly. The bay controller can send a message to the pick-put controller after the next received poll, indicating the switch activation or other event. The pick-put controller can indicate quantities by illuminating numeric displays on a light assembly, on a display in communications with the pick-put controller or on a display carried by the AMR. One or more light assemblies can be in communication with the pick-put controller (or cart controller) so that the worker can place a picked item into a container on or carried by the AMR consistent with the indicated quantities and actuate each proximity switch adjacent to a cart light assembly by placing an object within close proximity, typically 1 inch or less, to the light assembly. The light assembly on the bay can indicate a location and a quantity to pick, the light assembly on the cart or AMR can indicate a location and a quantity to put, a LED on the bay can indicate the location of a item to pick, a LED on the cart of AMR can indicate the location of an item to put and any combination thereof.

When all light assemblies associated with containers are illuminated and have been activated, the pick-put controller can send a message to the bay controller to deactivate the illuminated bay light assembly or bay light strip and the transmission session can end.

The pick-put controller can also be informed when the item is placed on a container associated with the AMR without the specific location on the AMR being known to the pick-put controller. The location of the item on the AMR can be known to the AMR controller in one embodiment.

In one embodiment, the transceiver connected to the pick-put controller has a communications range within which a transmitted message can be received. The bay controller would not receive messages from the pick-put controller until the pick-put controller is within the communications range. Therefore, the pick-put controller can be operated with communications to a single bay controller and not require communications to other bay controllers, a central server, or other facility wide information systems in real time. The communications range can be ten feet or less so that the pick-put controller and the bay controller do not communicate unless the pick-put controller is within such distance to the bay controller. The pick-put controller can be in communications with the AMR so that the AMR can be instructed as to when the target location has been reached, when the cart transceiver is properly aligned with the bay controller at the target location, when to travel to shipping, and where to return or otherwise locate within the facility.

One benefit from using close proximity communication is that the pick-put controller can recognize it is in close proximity to the AMR and target bay controller and can inform the pick-put controller to audibly direct the worker to “STOP”, instruct the AMR to stop and instruct the user to begin picking. This close proximity communications can be implemented without the use of other technologies, such as global positioning systems. This benefit is advantageous when the system is to be installed in locations that do not allow WiFi communications, that may include transmission interference inside metal buildings and facilities and that operate in facilities with other limitations or do not support constant communications between a pick-put controller and the bay controller or other computer system. The transmission between the pick-put controller and the AMR controller can occur in short and close proximity bursts so that there is no need for a facility wide wireless network of real time communications between the pick-put controller, AMR or center server.

With transceivers, there can be differences in transmission ranges due to component tolerance variations in manufacturing. The transceivers can include a calibration process in which an object is positioned at a desired distance to the controller. After the positioning of the object at a desired distance from the controller, the pick-put controller or bay controller can increase the transmission power from a low level to a higher level automatically until a signal is received by reflection of the signal from the object within a desired distance from the computer or controller. This process consequently calibrates the transmission and detection range of the object from the pick-put controller, cart controller or the bay controller and can be used to implement triggering in the proximity switch.

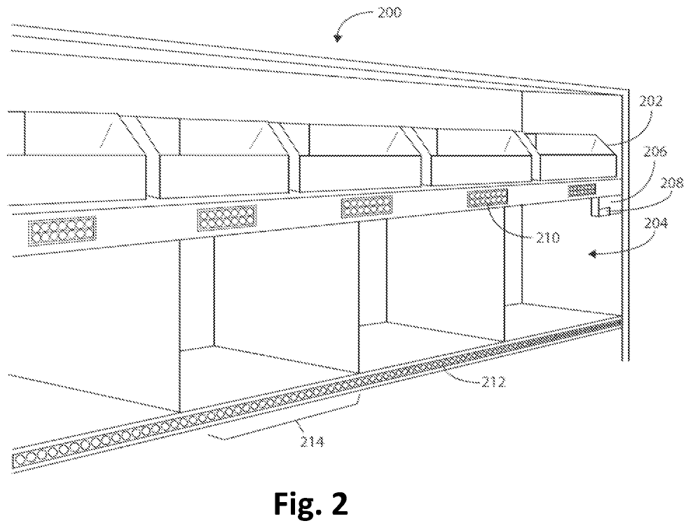

Referring to FIG. 3, the schematics of the system are shown. A facilities server 300 can include a facilities application for receiving and processing orders. Computer readable optimization instructions can be included on the facilities server that can aggregate orders and send the batch of orders to a pick-put controller. The pick-put controller 302 can receive the order and begin the picking process by instructing a worker and AMR to travel to the first position in the facility. In one embodiment, the worker can follow the AMR to the designated location. The pick-put controller 302 can be in communication with a cart controller 304 and cart transceiver 306. In one embodiment, the hardware and software can be included in the cart controller without the need for a cart controller. The term pick-put controller can be understood to include the hardware and software of the controller. The pick-put controller can be in communication with the bay controller 308 through the bay transceiver 310. The pick-put controller can be in communication with a container controller 312. The container controller can be the hardware and software that tracks and suggest a container to be placed on the cart or AMR. In one embodiment, the container controller can be a computerized system that can be in communication with the pick-put controller, the AMR controller or both. The pick-put controller can use the orders to be fulfilled and determine the containers that need to be placed on the cart or AMR. The pick-put controller can communicate with the container controller and cause the container controller to indicate a container from an inventory of containers that is to be retrieved and placed on the cart or AMR. The inventory of containers can be adjusted to reflect the removal of the container from the container inventory and placement of the container on the cart or AMR.

When orders are shipped, the pick-put controller can provide the container controller with the quantity of a container size that was used for shipping thereby indicating that the quantity of containers of the size that needs to be replenished. The AMR can be directed to a container supply area and be instructed that a quantity of containers of the size be retrieved and placed on the cart or AMR so that additional orders can be fulfilled. Therefore, container inventory can be managed.

Referring to FIG. 4, an example layout is shown. A facility can include several bays where items can be stored, and an AMR can travel to pick locations allowing for the collection of items for one or more orders where the items can be placed into containers associated with the order. Generally, a facility can include a cart preparation area 400 which can include an inventory of containers. In this area, the pick-put controller can be wired or wireless communications to a facility or other server that contains orders. Therefore, the number, sizes and types of container can be known, indicated and placed on the cart or AMR.

The server can transmit digital information concerning one or more orders to the pick-put controller so that attributes such as the picking location, photo, number of items to be picked are known to the pick-put controller. The picking location of order items transmitted to the pick-put controller can be composed of fields like zone, bay, shelf and position or other nomenclature. The orders selected to be transmitted to a pick-put controller can determine by randomly selecting orders, determine a path that the worker is to travel according to the orders transmitted to the AMR and indicating to the worker the travel path that seeks to minimize distance according to the orders that are transmitted to the cart controller

In one embodiment, the pick-put controller, itself or through a cart controller, can visually or audibly direct the worker to position the cart in an order communication area 400. The order communication area can be configured to transmit item picking requirement information from an aggregation of orders to the mobile pick-put controller. The server can also transmit information concerning containers that can be optimally sized for orders selected for picking to the cart controller for subsequent erection and placement on the AMR.

In one embodiment, the worker can be directed to container area 402 where containers that are to be placed on the AMR or associated cart are stored. The container area can be some distance from the order communication area. The container area can include a transmitter with a close proximity sensor that has a container area range 404. When the AMR is in the container area range, the AMR controller and Pic-put controller can detect that the AMR is in a container area range 404 and visually and audibly instruct the worker to “STOP” as well as to instruct the AMR controller to stop the AMR in this area. The containers that should be placed on the cart or AMR can be indicated audibly or visually on the pick-put controller, AMR or both.

For example, the display can provide container information allowing the worker to select a container from an inventory of containers and place them on the AMR or associated cart. In one embodiment, the container area can include a container indicator that can be actuated indicating that a container in an inventory of containers can be selected. The container light indicator can be disposed on a container shelf and illuminate showing the worker which container to select. The pick-put controller can be in communications with the server so that when the AMR enters the container area, a container controller can detect the presence of the AMR, illuminate container light indicators to identify the containers that are to be placed on the AMR and provide other container selection information to the worker. This process can be actuated when the AMR enters the container area range and does not require the AMR to scan, be scanned, or be connected to a controller in the container area. The container selection process can be initiated touchlessly and without any instructions.

In one embodiment, if a container isn't available for selection and placement on the AMR, the worker can indicate that the container is not available, such as by scanning a command code identifier (e.g., a barcode). In response the system can illuminate a container light indicator, such as a light indicator on the container area, adjacent to the a “next best” substitute container for selection and placement on the AMR.

When the containers are placed on the AMR, the pick-put controller can direct the worker to an area of the facility and send the AMR to that location to pick items required for one or more orders that were transmitted to and stored in the pick-put controller. For example, the worker and AMR may be directed to “Aisle 4, Bay 1.” A first bay 406 can include a first bay controller that can respond to the pick-put controller transmitting a message containing the first bay identifier information. While other bays controller can receive the cart transmitted message because the bay identifier being in the message does not match the other bay controllers' internal addresses, they need not respond. In one embedment the bay identification is transmitted within a first bay close proximity range 408.

In one embodiment the pick-put controller can poll with a message containing a target bay address, and when the cart is within the close proximity range, receives an acknowledgement message reply from the target bay controller with a matching bay address. After receiving this acknowledgement, the worker can be instructed to “STOP” and the AMR instructed to stop. The pick-put controller can have a close proximity range beyond which the transmission poll message of the pick-put controller does not extend. Therefore, the bay controller and the pick-put controller communicate only within the close proximity range.

The pick-put controller can instruct the worker to stop at the bay when the pick-put controller receives an acknowledgement message from the bay controller within the close proximity range, thereby serving a purpose similar to a global position system (GPS), but without the restrictions imposed upon GPS operating inside a metal building. The pick-put controller can also instruct the AMR to stop when the AMR is positioned at a location that enables close proximity communications with a bay controller. An important advantage of this close proximity communications is that a pick-put controller will not receive an acknowledgement message from a target bay controller that is at a great distance from the pick-put controller, such as when the pick-put controller is on the other side of the facility from the bay. It will only receive an acknowledgement message from a target bay controller that is in close proximity to the pick-put controller and thereby enables the pick-put controller to instruct the worker and AMR to stop at the designated, target location. The bay controller can be instructed by the pick-put controller to illuminate a bay light indicator indicating that the item associated with one or more orders is to be picked from the bay and placed in the appropriate container on the AMR.

In one embodiment, the bay controller can detect a first pick-put controller and AMR 410 within first bay close proximity range 406 and a second pick-put controller and AMR 412 within the first bay close proximity range 406. The bay controller can transmit an occupied indication message to the second pick-put controller so that the second pick-put controller can direct the second AMR to a different bay and direct the worker and AMR to the different bay. The second AMR can later be directed to return to the first bay after a period of time allowing the first AMR to complete its task at the first bay.

In one embodiment, a bay controller can enable multiple AMRs to pick from the bay if LED strips are used as bay light identifiers. A first pick-put control and AMR can illuminate the bay LED strip segments adjacent to the location of the items to be picked in a first color. Therefore, the worker using the first AMR selects items that are indicated with the first color. The bay controller can recognize the second pick-put controller and the second AMR and actuate the LED strip segment in a second color associated with the second pick-put controller and AMR. Therefore, a worker using the second AMR selects items that are indicated with the second color. If the same item is required by both AMRs, the LED colors associated with the AMRs can be interleaved in the bay LED strip segment.

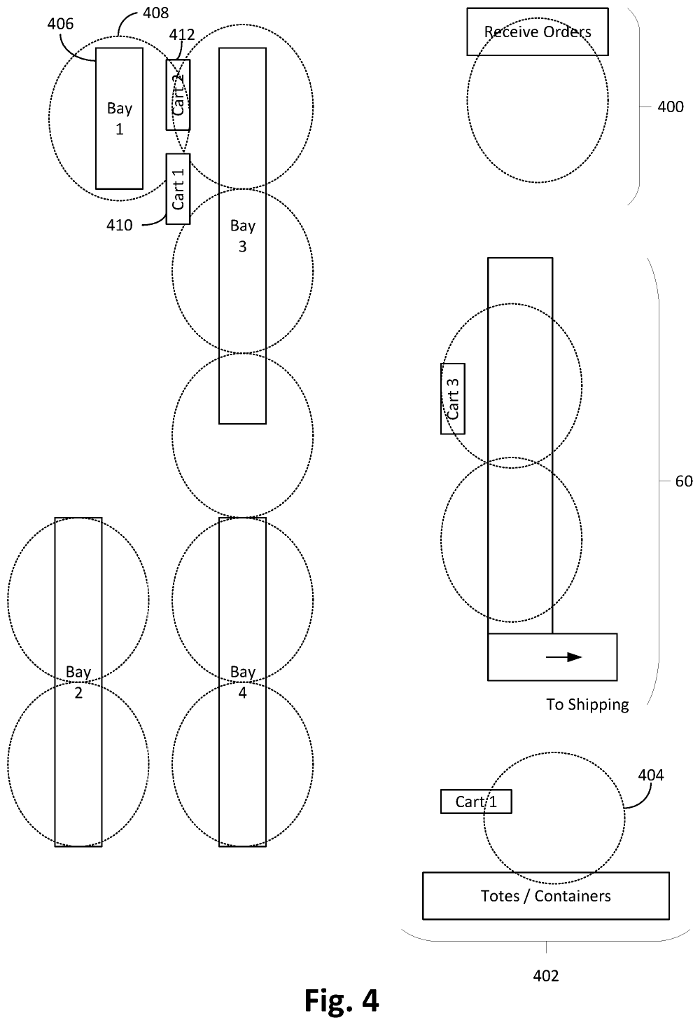

Referring to FIG. 5, a system 500 can receive orders for items. The system can include an order management system that was integrated with or be in communications with a warehouse management system, an order fulfillment system, an online ecommerce system, an inventory management system, an enterprise resource planning system, an accounting system, and any combination thereof. The entire order can be sent to one or more fulfillment vendors 502a and 502b for fulfillment. The order can be entered into the vendor's fulfillment system such as a warehouse management system 504. An optimizer 506 that can include computer readable instructions can be in electronic communications with system 504, allowing the transmission of data between the two systems.

The optimizer can determine, according to the dimensions and weights of the items in the order, preferred container(s) for receiving the order items so that the preferred container(s) will have minimal wasted space after all items have been placed in the container. The optimizer can include or be accessed by a warehouse management system, ordering system, inventory system, enterprise resource system and the like. In one embodiment, one or more items of an order can include information concerning its dimensions and weights so the server or pick-put controller can virtually arrange the items to be picked and placed in a container to optimize the size of the container so the container will have minimum unused space after placement and therefore reduce shipping costs. For example, the server or the pick-put controller can include computer readable instructions to analyze the dimensions and weight of the items to be placed in a container on the AMR or a cart pulled or pushed by the AMR, to predict how a worker will arrange the items in the container, including such item properties such as nesting, cavity fill, this-side-up and the like. The result of this analysis can be used to select the best container, from a set of available containers, and inform the worker of the best container size to be placed on the AMR or associated cart prior to picking or the best container size to be used to pack the order items after picking.

In one embodiment, a method of minimizing travel distance can be used by selecting orders in a batch wherein the items of each order are in relatively close proximity to each other. Therefore, the batch of orders has the picking process more locally arranged as opposed to dispersed throughout the warehouse. Using this system, the technologies are improved as the AMR(s) can travel less distance both individually and in the aggregate. In this embodiment, focus is placed on the locations of order items in in the facility and orders are selected for batching based upon item facility location, rather than seeking to minimize travel time with a randomly selected group of orders.

The pick-put controller can have communications with a server that can be in communication with a database containing one or more orders that are to be fulfilled. The server can be a standalone computer, part of an order fulfilment system, inventory system, procurement system enterprise resource planning system or other system that can be used for processing orders containing required items in one or more orders. The computer readable instructions on the server can batch orders together to optimize operational factors such minimizing travel distance, maximizing commonality of required products or minimizing wasted shelf space when difference size containers are used. The server can determine which batch of orders should be transmitted to a pick-put controller at 508 based on facility operational criteria, such as due date, carrier, geographical distance for shipment, random selection, etc. The server can select orders that include items in reasonably close proximity to each order and that have commonality of location such as in the same or nearby bays. Using these computer readable instructions, the travel time of the worker can be reduced and provide for items to be picked and put into multiple order containers when stopped at a particular bay.

By selecting orders with items in closer proximity to each other, the system is selecting orders to create a shortest travel path, individually and in the aggregate.

Once the orders are received by the pick-put controller, the worker can be directed to the designated position, the AMR can be directed to the designated position through the facility at 510, pick items at 512, and offload the filled containers at 514 so they can be shipped to the customer at 516. Communication between the server and the pick-put controller or between the server and AMR controller is not needed for the picking-putting process since all picking data is contained in the pick-put controller.

In one embodiment, orders can be aggregated for picking so that when pickled, wasted shelf space on the AMR and inside the shipping carton is minimized. In one embodiment, the orders selected by the pick-put controller and that are to be processed by the pick-put controller, can be selected to minimize empty space on carts, AMRs and containers.

When all items are picked and placed on containers on the cart or AMR, the AMR can be instructed to travel to a shipping area 414 (FIG. 4) wherein the pick-put controller can provide instructions to retrieve a container from the cart or AMR, add any necessary additional material (e.g., dunnage), retrieve a label if needed, seal the container and position and/or deposit the container appropriately so that it is ready for shipping.

In one embodiment, the AMR can be instructed to travel to a shipping area wherein the AMR controller can provide instructions to retrieve a container from the cart or AMR, add any necessary additional material (e.g., dunnage), retrieve a label if needed, seal the container and position and/or deposit the container appropriately so that it is ready for shipping.

In one embodiment, the AMR can be instructed to travel to a shipping area wherein the shipping container can recognize the AMR and provide instructions to retrieve a container from the cart or AMR, add any necessary additional material (e.g., dunnage), retrieve a label if needed, seal the container and position and/or deposit the container appropriately so that it is ready for shipping.

The container removed from the AMR can be a shipping container or an intermediate container. In the case of the intermediate container, a worker can move items from the intermediate container to a shipping container and the items shipped. The AMR can then be made available for another batch of orders.

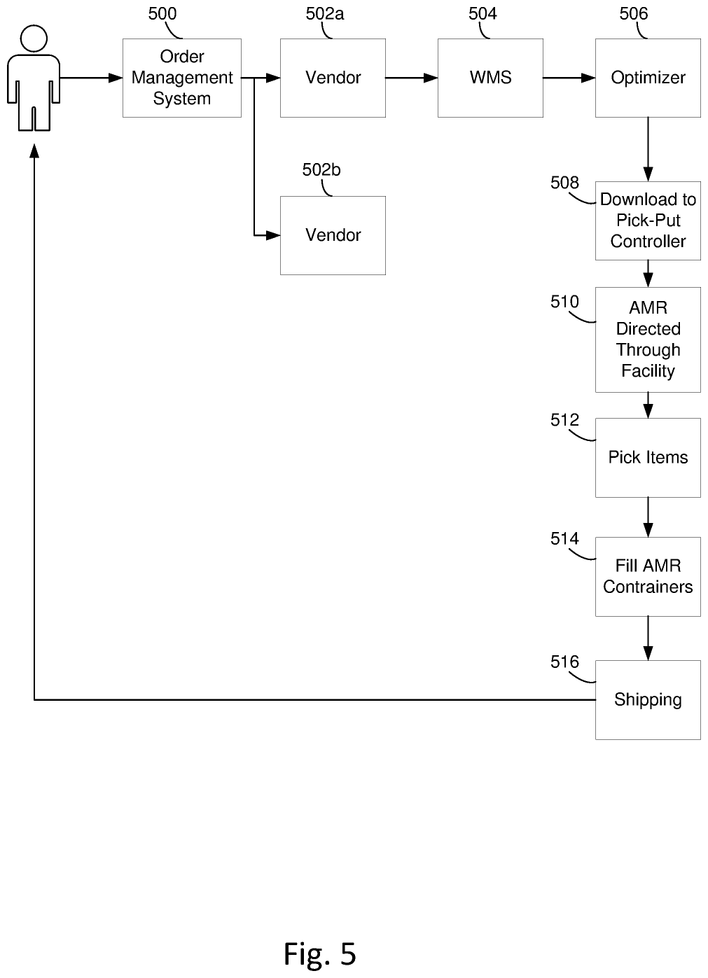

Referring to FIG. 6, the cart or bay controller can be in communication with its proximity sensor or switch 600 within the pick-put controller or bay controller. The switch can be a contactless, distance-tunable switch. Due to manufacturing and component variations, contactless switches generally do not have consistent activation ranges. Therefore, the switches can be calibrated for the respective devices so that the activation range 602 is in the range of one-half inch to five inches. This process can be accomplished by the cart or bay controller being in communications with its proximity switch, an emitter that transmits a wireless signal, an object placed in front of the switch at a desired distance and a sensor that can detect the wireless signal after it reflects off the object. Computer readable instructions can increase the power level, as needed, until the sensor within the switch detects the wireless signal reflection at a desired distance.

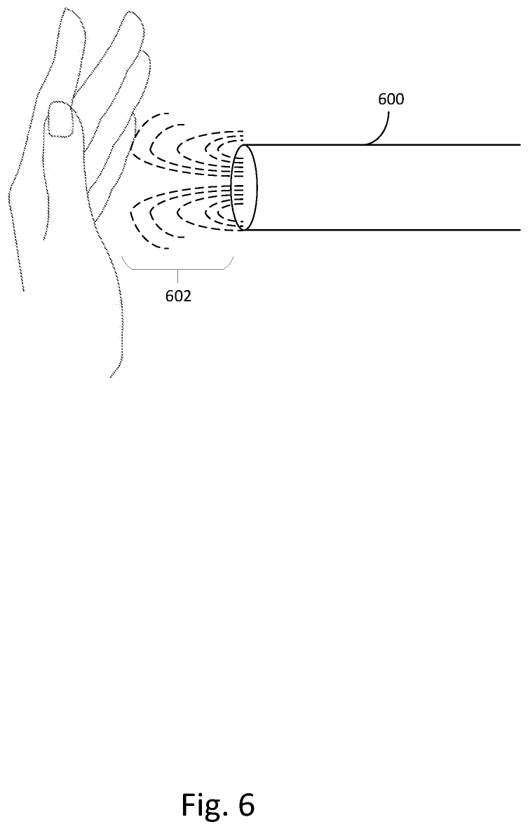

Referring to FIG. 7, the operation of the system is shown. The system can be initiated at 700. The server can be the same server that stored orders such as one used with a warehouse management system, ordering system, or other commercial transaction system or can be a different computer that communicates with the above-mentioned server. Orders placed by end customers include one or more items to be delivered to the end customers. The orders are received by the server and batched at 702. The server can transmit the batched orders to a pick-put controller at 704 or other transmission path allowing order to be received by the pick-put controller. The server can store orders individually or in batches on a database stored on the pick-put controller so that the controller can retrieve the batch of orders. Orders can be batched and transmitted to a separate mobile pick-put controller allowing multiple AMRs to concurrently pick items in the facility. The server can also determine the size of the container that should be associated with each order and transmit the container size to the mobile pick-put controller at 706. The AMR can then be positioned at a container inventory at 708 and a container to be placed on the AMR can be associated with an order that was transmitted to the AMR. The container can be retrieved from an inventory of containers and placed on the AMR in a location indicated by a light assembly. The AMR can be directed by the pick-put controller to travel to a bay at 710. The bay controller can establish a “picking session” when a message transmitted to the bay controller from the cart controller and the AMR is within an area range in close proximity to the bay controller. The bay identifier can be a unique value associated with that bay or portion of a bay. The bay identifier can be transmitted by the pick-put controller or cart controller in a close proximity area range so that only bay controllers within a predetermined distance of the cart controller can receive the bay identifier If a second cart attempts to communicate with the bay controller that is in a “picking session” the bay controller can send a message to the pick-put controller on the second cart indicating the bay is unavailable until the current “picking session” has terminated.

When the mobile pick-put controller (or cart controller) transmits the bay identifier, the bay controller can respond with an acknowledgement that the bay controller is in close proximity to the pick-put controller. If so, the pick-put controller instructs the worker to stop at the bay and instructs the AMR to stop at the bay. The mobile pick-put controller, itself of through a cart controller, transmits item information to the bay controller and according to the item information, the bay controller activates a bay light indicator depicting which item(s) should be picked. The pick-put controller or cart controller can then activate one or more cart light assemblies that indicate one or more containers that should receive the picked items in indicated quantities. The worker can be instructed to pick a number of the same item and place a quantity of that item in one or more containers. Because the AMR transmits the location information to the bay controller, the bay controller does not have to be in communication with the server computer. Once all items are picked, the worker is directed to a shipping area at 712. The container can then be removed from the AMR and prepared for shipping, or the items can be placed in a temporary location so that the items will later be placed into a shipping container for shipping.

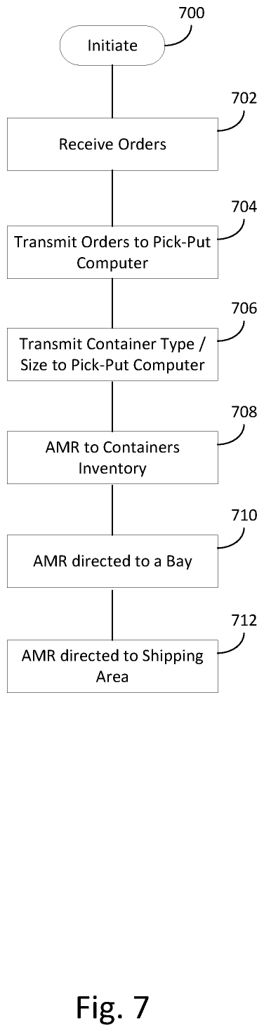

Referring to FIG. 8, one example of a bay controller is shown that includes a housing 800 that can carry a circuit board 802 that can be in communications with a transceiver 804 with the same form factor and design. The housing can carry emitters (e.g., IR emitters) 806. On or more lights 808 can be actuated by the circuit board and can provide functionality for notifications, alerts, debugging, programming, and the like. A receiver 810 (e.g., IR receiver) can be carried by the circuit board.

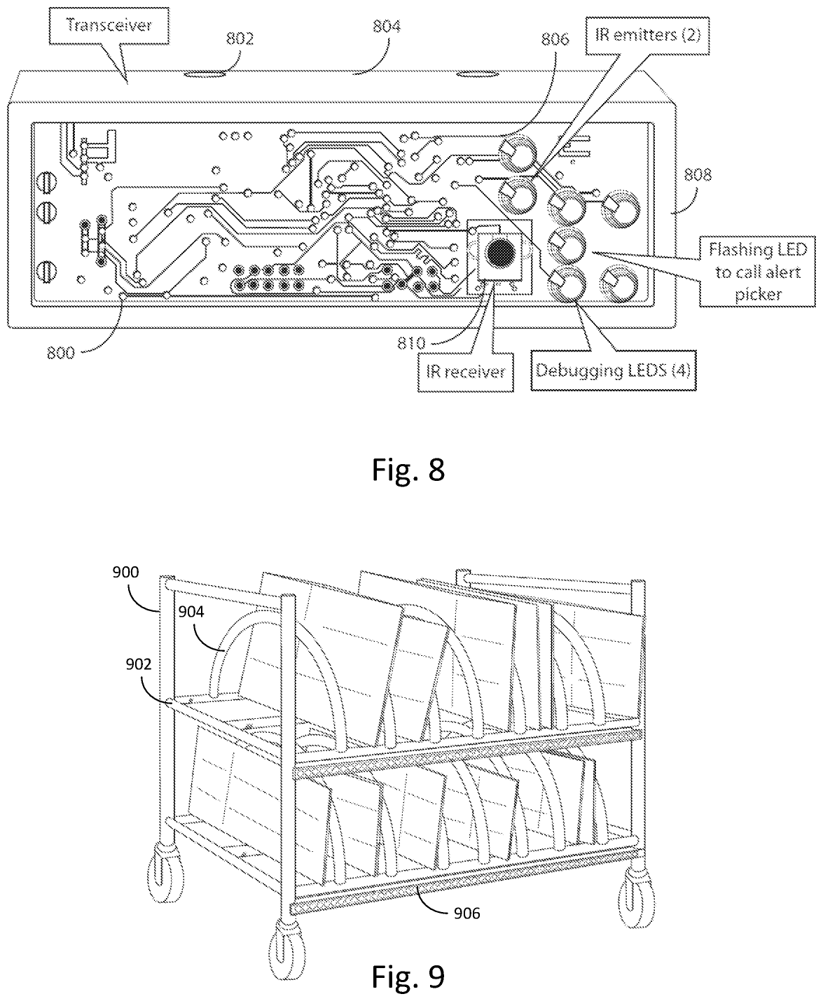

Referring to FIG. 9, the system can include assisting with the selection and provision of containers that can be used for placement on the cart, bay, for shipping and the like. A rack 900 can be stationery or mobile and can include shelves 902 with dividers 904. Indicators 906 can be associated with each shelf or portion of a shelf and can indicate to a worker where a container is located. The container rack can include a computer or controller that can communicate with the pick-put controller mounted on an AMR or picking cart so that when the AMR or cart is in need of a container, the cart can position the worker near the container rack and indicate which container the worker is to select to place on the cart. For example, the container rack computer can receive information from the pick-put controller that the prior use of the container rack resulted in a container being removed from the rack. The rack, now in need of a replacement container, can transmit to the container pick-put controller the container needed. The container rack can then indicate, using indicators (e.g., LEDs) which container to select from the container cart that is to be placed on the picking cart. This function can be accomplished with the pick-put controller in close proximity and close communications to the container cart without the need for the computers or containers to be in communications with a central computer system. The cart can receive replacement containers from the cart container as needed. The container cart can be a stationery inventory location so that when a container is needed, the pick-put controller can instruct the worker to position the cart at or near the container cart.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the system should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. An autonomous augmentation to a pick-put fulfillment system comprising:
a pick-put controller having a set of orders to be fulfilled;
an autonomous mobile robot (AMR) having an AMR controller in communications with the pick-put controller having a container for receiving a picked item;
wherein the pick-put controller is adapted to determine a travel path through a facility according to the set of orders, transmit a destination to the AMR controller according to the travel path, communication with a bay controller to actuate a bay light assembly to indicate an item to be picked, actuate an AMR light assembly to indicate a position on the AMR and/or a carried by the AMR where to put the item, provide instructions to a display indicating a quantity of the item to be picked, and,
wherein the AMR controller is adapted to travel to the destination according to the pick-put controller and travel to a shipping location according to a completion of a pick-put process according to the set of orders.

2. The system of claim 1 wherein the pick-put controller is carried by the AMR.

3. The system of claim 1 including a set of containers that are carried by the AMR.

4. The system of claim 1 including a set of containers that are carried by a cart wherein the cart is carried by the AMR.

5. The system of claim 1 wherein the actuation of an AMR light assembly results from a pick-put controller communication with an AMR light assembly controller.

6. The system of claim 1 wherein the actuation of an AMR light assembly results from a pick-put controller communication with an AMR controller.

7. The system of claim 1 wherein the pick-put controller is adapted to determine a container size and/or a container type needed for the set of orders, instruct the AMR to travel to a container inventory area and indicate containers to be placed on the AMR.

8. The system of claim 1 wherein the AMR includes a motorized unit and a container unit.

9. An autonomous augmentation to a pick-put fulfillment system comprising:
a pick-put controller having a set of orders to be fulfilled;
an AMR controller in communications with the pick-put controller having a container for receiving a picked item;
wherein the pick-put controller is adapted to determine a travel path through a facility according to the set of orders, transmit a destination to the AMR controller according to the travel path, communication with a bay controller to actuate a bay light assembly to indicate an item to be picked, actuate an AMR light assembly to indicate a location where to put the item, provide instructions to a display indicating a quantity of the item to be picked, and,
wherein the AMR controller is adapted to travel to the destination according to the pick-put controller and communication with the bay controller to determine the location where a motorized unit should be positioned.

10. The system of claim 9 wherein the pick-put controller includes a display indicated the quantity of an item to pick.

11. An autonomous augmentation to a pick-put fulfillment system comprising:
a pick-put controller having a set of orders to be fulfilled;
an AMR controller in communications with the pick-put controller having a container for receiving a picked item;
wherein the pick-put controller is adapted to determine a set of orders according to a travel path through a facility, transmit a destination to the AMR controller according to the travel path, communication with a bay controller to actuate a bay light to indicate an item to be picked, actuate an AMR light to indicate a location where to put the item, provide instructions to a display indicating a quantity of the item to be picked, and,
wherein the AMR controller is adapted to travel to the destination according to the pick-put controller.

12. The system of claim 11 wherein the travel path is a optimized travel path to minimize an aggregate travel distance.

13. The system of claim 12 where the aggregate travel distance is an aggregate of multiple motorized units.

14. The system of claim 11 wherein the pick-put controller includes a display indicated the quantity of an item to pick.

15. The system of claim 11 wherein the AMR controller includes a display indicated the quantity of an item to pick.

16. The system of claim 11 wherein the bay light includes a display adapted to display a quantity of items to pick.

17. The system of claim 11 wherein the pick-put controller includes a display indicated the quantity of an item to put.

18. The system of claim 11 wherein the AMR controller includes a display indicated the quantity of an item to put.

19. An autonomous augmentation to a pick-put fulfillment system comprising:
a pick-put controller having a set of orders;
an AMR controller in communications with the pick-put controller and carried by a motorized unit;
a container carried by the motorized unit;
a bay controller in communications with the pick-put controller;
wherein the pick-put controller is adapted to transmit a destination to the AMR controller according to the set of orders, communication with the bay controller to actuate a bay light to indicate an item to be picked, actuate a put to indicate a location where to put the item, and,
wherein the AMR controller is adapted to travel to the destination according to the pick-put controller.

20. The system of claim 19 wherein the pick-put controller is adapted to provide instructions to a display indicating a quantity of the item to be picked.

21. The system of claim 19 wherein the pick-put controller is adapted to provide instructions to a display addressing a quantity of the item to be put.

22. The system of claim 19 wherein the pick-put controller is adapted to instruct the AMR to travel to a shipping location upon completion and./or partial completion of fulfillment of the set of orders.
